(19) United States
(12) Patent Application Publication
(10) Pub. No.: US 2014/0169860 A1
(43) Pub. Date: Jun. 19, 2014

(54) DEVICE FOR LOCKING A BODY ONTO A ROD

(71) Applicant: Sylvain Meunier, Boutigny sur Essonne (FR)

(72) Inventor: Sylvain Meunier, Boutigny sur Essonne (FR)

(73) Assignee: DURA AUTOMOTIVE SYSTEMS SAS, Bievres (FR)

(21) Appl. No.: 14/114,702

(22) PCT Filed: Apr. 2, 2012
(86) PCT No.: PCT/FR2012/050710

§ 371 Date: Dec. 18, 2013

(30) Foreign Application Priority Data
Apr. 29, 2011 (FR) 1153658

(51) Int. Cl. F16B 7/04; F16B 9/02

(52) U.S. Cl. CPC F16B 7/04; F16B 9/023
USPC 403/187

(57) ABSTRACT

A body has a portion suitable for receiving a snap-fitting member that cooperates with a portion of a rod engaged in the portion of the body, the snap-fitting member being shaped so as to occupy a first retracted position in which the body can be freely moved on the rod and a second locked position in which the body is translationally locked on the rod. The snap fitting member may automatically switch from a first retracted unlocked position to a second locked position without a user having to exert any manual pressure on the snap-fitting member.

### BACKGROUND

1. Technical Field

The invention relates to a device for locking a body onto a rod.

The invention has a particularly advantageous application in automotive engineering, especially for adjustably fastening a cable end, for instance in order to control the gear selection and changing in a gearbox.

2. Description of the Related Art

According to the prior art, the body has a portion in the form, for example, of a cage suitable for receiving a snap-fitting member. This snap-fitting member cooperates with a part of the rod which is itself engaged in the cage. The snap-fitting member has locking features that cooperate with matching features of the rod. These features consist, for instance, of a system of matching teeth. Also, the snap-fitting member is engaged in the body, particularly in the cage, and is shaped so as to occupy a first retracted position in which the body can be freely moved on the rod and a second locked position in which the body is translationally locked on the rod. In order to change from the retracted position to the locked position, manual pressure must be exerted on the snap-fitting member in order to ensure cooperation of the system of matching teeth.

In other words, locking is performed by an operator and such locking therefore cannot be guaranteed in every case. In fact, if the assembly worker does not apply enough pressure on the snap-fitting member, the latter's teeth, which are generally made of plastic, may deform when they come into contact with the teeth of the adjusting rod which are generally made of metal. This can result in inadequate locking of the adjusting rod.

Similarly, it has been observed that if the environment on the vehicle assembly line is very congested, it can be very difficult for the operator to access the snap-fitting member in order to ensure locking.

### BRIEF SUMMARY

The invention has set itself the object of overcoming these drawbacks in a simple, dependable, effective and efficient manner.

The problem that the invention aims to resolve is to be able to ensure locking of the body on the rod without the need to manually exert pressure on the snap-fitting member and to ensure such locking in an advantageous manner.

To solve this problem, the snap-fitting member is controlled by means capable of allowing it to automatically switch from a first retracted unlocked position to a second locked position without having to exert any manual pressure on said snap-fitting member (3).

To solve the problem of automatically ensuring the snap-fitting function that corresponds to locking the body on the rod, these means consist of a combination of an element suitable for exerting a constant force on the snap-fitting member and a removable element suitable for temporarily holding the snap-fitting member in the first retracted position so that, after said removable element has been removed, the snap-fitting member is subjected to the action of the pressure force exerted by the other element which concomitantly and automatically causes locking of the body on the rod.

To solve the problem of exerting sufficient force on the snap-fitting member, the element suitable for exerting a constant pressure force is a compression spring mounted between the snap-fitting member and a cover connected to the body that is locked in position.

To solve the problem of maintaining the snap-fitting member in its retracted position in order to allow adjustment of the body relative to the rod or vice versa, the removable element is a tab that is engaged between a portion of the snap-fitting member and a portion of the body, so as to maintain said member in its retracted position which corresponds to compression of the spring.

The tab is engaged through the snap-fitting member in a semi-circular bearing surface that is capable of cooperating with the rod in the locked position, said tab being supported by a portion of the body.

Given these inherent characteristics of the invention, to ensure locking it is therefore sufficient to pull the tab in order to release the snap-fitting member which, under the action of the compression spring expanding, is snap fitted onto the rod.

To this end and in order to ensure locking as such, which corresponds to translationally locking the rod relative to the body, the semi-circular bearing surface of the snap-fitting member is formed by an indentation that is capable of enclosing a section of the rod, said bearing surface having locking features that cooperate with matching features on part of said rod.

The matching locking features of the semi-circular bearing surface of the snap-fitting member and of the rod consist of a system of protrusions and hollows that act as a system of teeth.

In another embodiment, the compressed spring is mounted between the snap-fitting member and the cover and each of its ends are engaged and centered in annular recesses.

To solve the problem of making it possible to connect the cover to the corresponding portion of the body with locking in the raised position, in particular, the cover has internal locking tabs that are capable of cooperating with slots in the portion of the body that receives the snap-fitting member, thus ensuring its connection and locking in position.

As already stated, the device has a particularly advantageous application in the automotive field; the body in this case can be a cable end secured to the adjusting rod which is itself connected to the actual cable.

### BRIEF DESCRIPTION OF THE SEVERAL VIEWS OF THE DRAWINGS

The invention is explained below in greater detail, reference being made to the accompanying drawings in which:

FIG. 1 is a perspective view, before assembly, of the main components of the locking device according to the invention.

FIG. 2 is a perspective view of the device in its unlocked position in order to allow adjustment of the body relative to the rod.

FIG. 3 is a view corresponding to FIG. 2 in the position where the body is locked on the rod following removal of the locking tab.

FIG. 4 is a perspective view of the top cover.

FIG. 5 is a perspective view of the snap-fitting member.

FIG. 6 is a cross-sectional view of the device in its unlocked position.

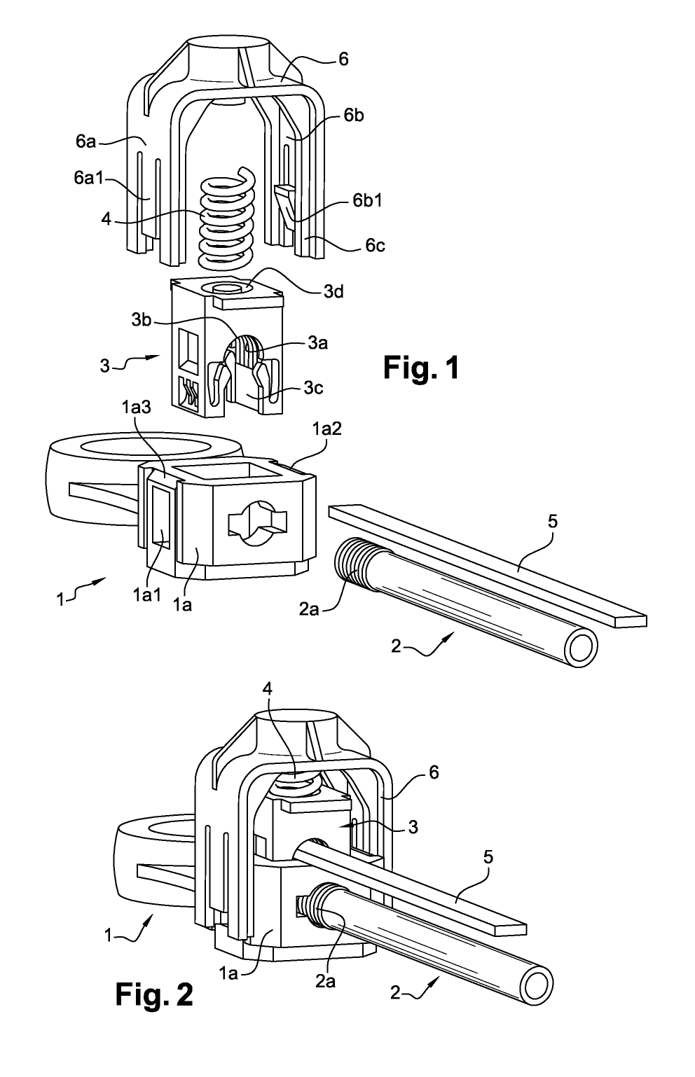

### DETAILED DESCRIPTION

As stated earlier, the device for locking a body (1) on a rod (2) or other cylindrical element has a particularly advantageous application in the automotive field, especially in the case of a cable end such as those that are routinely used to control the gear change and selection functions of a gearbox. In this example, the body (1) may constitute the cable end itself, whereas the rod (2) is an adjusting rod secured to the cable or another equivalent member. The cable end (1) may have a portion (1a) forming a cage designed to receive a snap-fitting member (3). This snap-fitting member has locking features (3a) that cooperate with matching features (2a) of the rod in order to ensure that end (1) is translationally locked on adjusting rod (2). Snap-fitting member (3) is shaped to occupy a first retracted, unlocked position in which cable end (1) can be moved freely on rod (2) and a second locked position in which cable end (1) is translationally locked on rod (2).

According to one basic aspect of the invention, snap-fitting member (3) is subject to means capable of allowing it to automatically switch from the first retracted position to the second locked position with the aim of avoiding having to manually exert any pressure on said snap-fitting member. These means consist of a combination of an element (4) suitable for exerting a constant force on snap-fitting member (3) and a removable element (5) capable of temporarily holding said snap-fitting member (3) in its first retracted position.

The element suitable for exerting pressure (4) consists of a spring mounted in compression between snap-fitting member (3) and cover (6).

Cover (6) is connected to the outside of cage (1a). For example, cover (6) has a cross-section substantially in the form of an inverted U, the legs (6a) and (6b) of which are designed to top and enclose the transverse section of cage (1a). These legs (6a) and (6b) have elastically deformable locking tabs (6a1) and (6b1) that are able to cooperate with openings (1a1) and (1a2) formed in the thickness of the lateral surfaces of the cage (1a). The ends of spring (4) are engaged in annular recesses (6d) and (3d) which are formed on the inner upper part of cover (6) and on the top of snap-fitting member (3) respectively. To ensure centering of cover (6) relative to cage (1a), legs (6a) and (6b) of the cover may internally have ribs (6c) that cooperate with grooves (1a3) formed over the height of the side surfaces of cage (1a) on either side of openings (1a1) and (1a2).

As already mentioned and as known from the prior art, snap-fitting member (3) has locking features (3a) that cooperate with matching features (2a) of rod (2). Thus, snap-fitting member (3) has a semi-circular bearing surface (3b) formed by an indentation (3c) that is capable of enclosing a section of rod (2). The diameter of semi-circular bearing surface (3b) corresponds substantially to the diameter of rod (2). This semi-circular bearing surface (3b) has locking features (3a) that cooperate with matching features (2a) on part of rod (2), in particular on its free end. These matching locking features can consist of a system of protrusions and hollows that act as a system of teeth. Note that snap-fitting member (3) is generally made of plastic whereas adjusting rod (2) is made of metal.

Element (5) consists of a tab capable of being engaged through snap-fitting member (3) in semi-circular bearing surface (3b), this tab being supported on the top surface of cage (1a). In other words, tab (5) ensures locking of snap-fitting member (3) in its retracted position, the position in which the locking features (3a) of semi-circular bearing surface (3b) do not mesh with the matching locking features (2a) of rod (2) (FIG. 2). In this locking position, spring (4) is compressed. Cover (6) is connected to cage (1a) by means of tabs (6a1) and (6b1). Note that in this position, tabs (6a1) and (6b1) are in their upper stop position in openings (1a1) and (1a2) in cage (1a) (FIG. 2). In this position, it is therefore possible to translationally move cable end (1) relative to rod (2) or vice versa in order to obtain the desired adjustment.

To ensure locking in the desired adjustment position, it is sufficient to remove tab (5) which releases snap-fitting member (3). Due to the effect of expansion of spring (4), the latter exerts a downwardly directed pressure force on snap-fitting member (3), concomitantly causing snap fitting of said member (3) on rod (2). This results in cooperation of the system of teeth (3a) of member (3) and teeth (2a) of rod (2). Note that the force exerted by spring (4) is large in order to avoid any deformation of the system of teeth on locking member (3) which are generally made of plastic, as indicated, when they come up against the teeth (2a) on rod (2). In fact, the teeth can slide over each other without deformation.

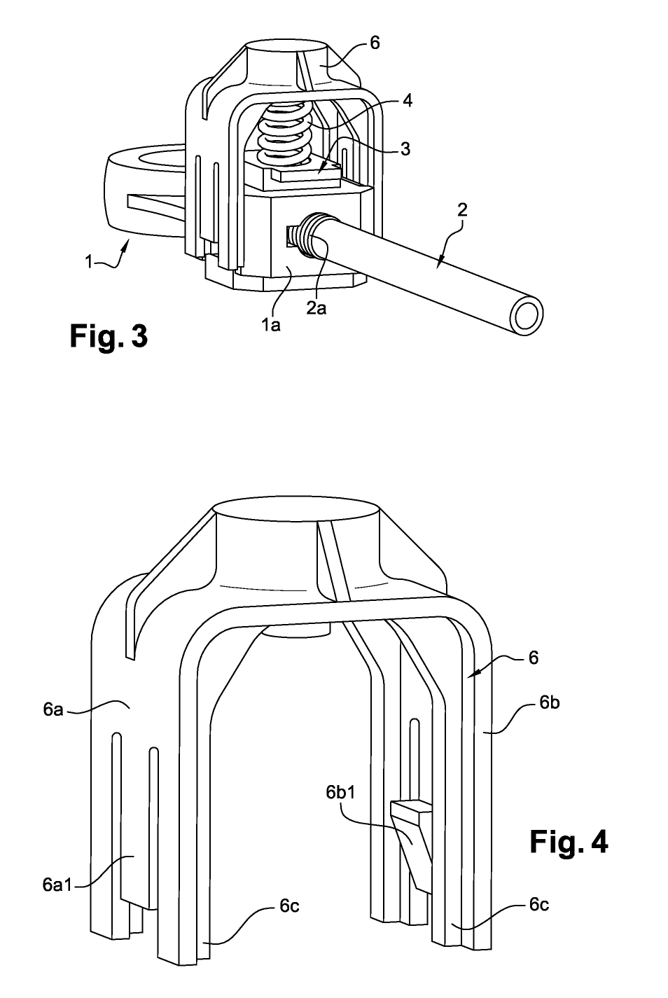

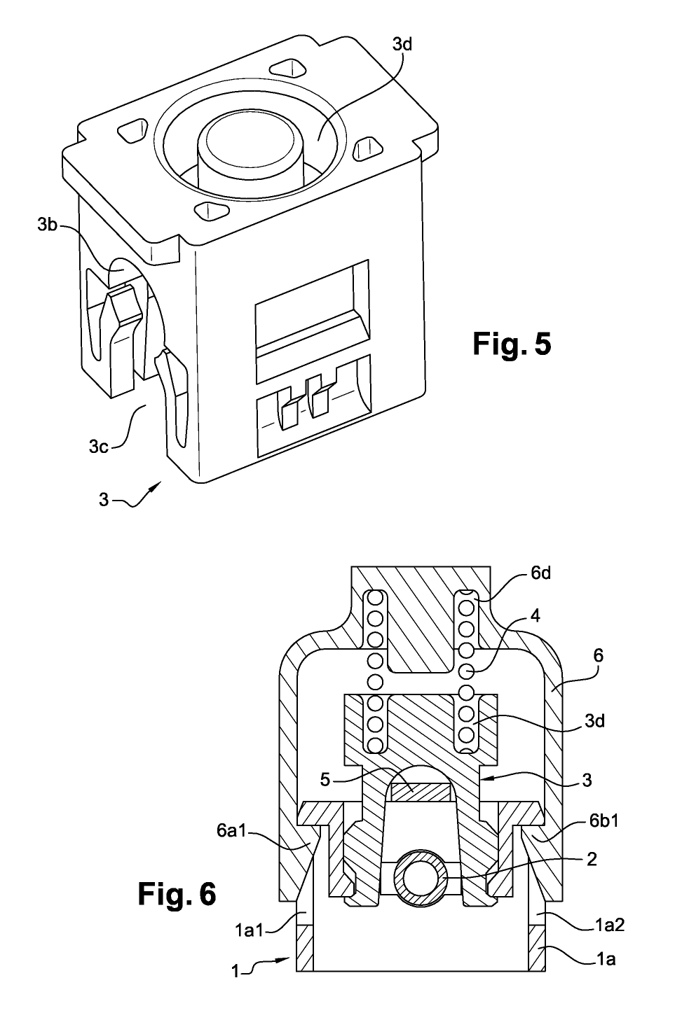

It follows from these characteristics that the device according to the invention makes it possible to ensure automatic blocking and locking of cable end (1) on rod (2) as shown, in particular, in FIGS. 2 and 3 of the drawings.

In the as-delivered position, tab (5) is engaged, as indicated, between the semi-circular bearing surface (3b) of snap-fitting member (3) and the upper surface of cage (1a). In this position, snap-fitting member (3) is blocked in its retracted, unlocked position, thus allowing free movement of cable end (1) relative to rod (2) or vice versa, given the fact that the matching systems of teeth of said member (3) and of said rod (2) are not meshed. Also in this position, spring (4) is strongly compressed between cover (6) and the top surface of the snap-fitting member (FIGS. 2 and 6).

Having obtained the desired adjustment, to ensure locking corresponding to locking of cable end (1) relative to rod (2), it is sufficient to remove tab (5). As a result and concomitantly, the release of snap-fitting member (3) which, due to the action of compression spring (4) expanding, snaps onto rod (2), places the two systems of matching teeth (3a-2a) in a position in which they cooperate. In other words, according to these aspects, the operator no longer has to exert manual pressure on snap-fitting member (3), it is sufficient for the operator to remove the tab.

These aspects have numerous advantages. The force exerted on tab (5) in order to remove it is virtually zero compared with the pressure that previously had to be exerted on the snap-fitting member. It is also observed that locking is much faster because the action of removing the tab is much quicker than the action of pressing on the snap-fitting member.

Based on the prior art, if the environment of the vehicle was very congested, it was very difficult for the operator to get his hand in to perform the manual locking operation by pressing on snap-fitting member (3). In this situation, according to the invention, it is possible to alter the length of removable tab (5) in order to make it easily accessible to the operator, consequently making locking easier.

In addition, given the fact that each locking operation requires removing a removable tab, the removable tabs can be saved in order to perform subsequent traceability checks.

Its advantages are readily apparent from the description, the following features in particular being emphasized and underlined:

The productivity gains achieved because there are fewer operations and their durations are reduced.

The quality of assembly and locking thanks to eliminating snap-fitting problems.

The accessibility of the device, even in case of very congested environments.

Effectiveness and the result obtained.

The possibility of performing traceability checks.

1. A device for locking a body on a rod, the body having a first portion suitable for receiving a snap-fitting member that cooperates with a portion of the rod that is engaged in the first portion of the body, the snap-fitting member being shaped to occupy a first retracted position in which the body can be moved freely on the rod and a second locked position in which the body is translationally locked on the rod, wherein the snap-fitting member is controlled by means capable of allowing it to automatically switch from a first retracted unlocked position to a second locked position without having to exert any manual pressure on the snap-fitting member, said means consisting of a combination of an element suitable for exerting a constant pressure force on the snap-fitting member and a removable element suitable for temporarily holding the snap-fitting member in the first retracted position, so that, after the removable element has been removed, the snap-fitting member is subjected to the action of the pressure force exerted by the other element which concomitantly and automatically causes locking of the body on the rod.

2. (canceled)

3. The device according to claim 1, wherein the element suitable for exerting a constant pressure force is a compression spring mounted between the snap-fitting member and a cover connected to the body that is locked in position.

4. The device according to claim 1, wherein the removable element is a tab that is engaged between a portion of the snap-fitting member and the first portion of the body, so as to maintain the member in its retracted unlocked position which corresponds to compression of the spring.

5. The device according to claim 4, wherein the tab is engaged through the snap-fitting member in a semi-circular bearing surface that is capable of cooperating with the rod in the locked position, the tab being supported by the first portion of the body.

6. The device according to claim 5, wherein the semi-circular bearing surface of the snap-fitting member is formed by an indentation of the snap-fitting member that is capable of enclosing a section of the rod, the semi-circular bearing surface having locking features that cooperate with matching features on part of the rod.

7. The device according to claim 6, wherein the matching locking features of the semi-circular bearing surface of the snap-fitting member and of the rod consist of a system of protrusions and hollows that act as a system of teeth.

8. The device according to claim 3, wherein the compressed spring is mounted between the snap-fitting member and the cover and each of its ends are engaged and centered in annular recesses.

9. The device according to claim 3, wherein the cover has internal locking tabs and that are capable of cooperating with slots and in the first portion of the body that receives the snap-fitting member, thus ensuring connection of the cover and its locking in position.

10. A use of the device according to claim 1 in the automotive field, the body consisting of a cable end connected to the rod.
